(19) United States
(12) Patent Application Publication
(10) Pub. No.: US 2004/0073944 A1
(43) Pub. Date: Apr. 15, 2004

(54) Server-based software architecture for digital television terminal

(75) Inventor: Robert C. Booth, Jamison, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/270,998

(22) Filed: Oct. 15, 2002

(51) Int. Cl. H04N 7/173

(52) U.S. Cl. 725/131; 725/120; 725/110

(57) ABSTRACT

Server software is utilized as a fundamental building block for the software architecture of digital television terminals (DCTs) and related devices (remote clients). For example, a web page may be stored on a digital terminal for access by a user of a client device to request specific actions to be performed or to request information. The client device communicates user requests to the digital terminal, whereupon an appropriate web page is retrieved by the server software and transmitted to and displayed on the client device. The user may subsequently make a selection via the web page, whereupon the client device sends the request back to the digital terminal. The client device can be used, e.g., to request a specific television channel via a web-type interface, in response to which the server software in the terminal will tune an associated television and return a new web page to the client device, indicating that the channel was successfully tuned.

### TECHNICAL FIELD

The present invention relates to interactive digital television terminals, and more particularly to software architecture for digital set-top boxes.

### BACKGROUND ART

Recent advances in cable and satellite distribution of subscription and “on-demand” audio, video and other content to subscribers have given rise to a growing number of digital set-top boxes/television terminals (sometimes referred to as Digital Consumer Terminals or “DCTs”) for decoding and delivering digitally broadcast programming. These boxes often include additional circuitry to make them compatible with older analog encoding schemes for audio/video distribution. As the market for digital multimedia content of this type grows and matures, there is a corresponding growth of demand for new, more advanced features.

Older-style analog set-top boxes (terminals) and first-generation digital set-top boxes are primarily aimed at providing television programming for display on a television set. Such set-top boxes are relatively simple in concept and provide limited functionality, with little or no opportunity for interaction, few configuration options, and little or no set-up required. Subscription services (e.g., programming) such as movie channels and pay-per-view events is usually scrambled/encoded, requiring a decoder. Accordingly, most such set-top boxes provide de-scrambling/decoding capability, requiring some remote control of the set-top box by the service provider. However, the remote control requirement is very basic and simple, requiring little in the way of sophisticated interaction with the set-top box. This interaction is essentially transparent to the end-user of the set-top box (subscriber), since it usually occurs over the cable (or satellite) connection to the service provider's facility and requires nothing of the subscriber beyond an agreement to pay for the subscription services.

By way of contrast, newer digital set-top boxes offer considerably increased functionality, and many new features that were previously unavailable. These features offer considerable opportunity for direct subscriber interaction with the set-top box, and in some cases actually require interaction. Some examples of these newer features are: Electronic/Interactive Program Guide (EPG/IPG), interactive video programming, Personal Video Recorder (PVR) capability, coordination with other devices (stereos, VCR's, DVD's etc.), subscription games, interactive retrieval of program-related data, interactive shopping, etc.. Often, these features require at least some subscriber-specific setup. This type of setup is considerably more complicated than simple access authorization, and may require entry of some of a subscriber's personal information, such as credit card numbers, passwords, etc.

In some set-top boxes, this requirement for interaction has been satisfied by including an interactive “web-browser” client application into the set-top box, whereby the set-top box presents a series of “web pages” to the user allowing options to be selected and data to be entered. The use of a web-browser client provides a scaleable, expandable framework for interaction with the subscriber (and/or service personnel), and offers the service provider a reasonably straightforward, intuitive means for creating custom “web pages.” However, a client browser in a set-top box does not permit access by remote devices to control the content, services and data available therein.

### GLOSSARY

Unless otherwise noted, or as may be evident from the context of their usage, any terms, abbreviations, acronyms or scientific symbols and notations used herein are to be given their ordinary meaning in the technical discipline to which the invention most nearly pertains. The following glossary of terms is intended to lend clarity and consistency to the various descriptions contained herein, as well as in prior art documents:

| | |
|---|---|
| Browser | Or “Web Browser”. A Client program (software) that is used to |
| | look at various kinds of Internet resources. |
| Client | A software program that is used to contact and obtain data from |
| | a Server software program on another computer, often across a |
| | great distance. Each Client program is designed to work with |
| | one or more specific kinds of Server programs, and each Server |
| | requires a specific kind of Client. A Web Browser is a specific |
| | kind of Client. |
| DCP | Digital Convergence Platform. Motorola Inc.'s Digital Conver- |
| | gence Platform is a plug-and-play consumer-electronics product |
| | that combines an interactive digital cable terminal with popular |
| | home-theater system entertainment technologies - such as a |
| | DVD player, CD audio, and an audio/video receiver. The DCP |
| | platform also provides a gateway to broadband services such as |
| | video-on-demand movies, local source information, electronic |
| | programming guides, more channels of impulse pay-per-view |
| | movies and events, and more. |
| DCT | Digital Consumer Terminal, or set-top (box). The DCT2000 is a |
| | basic digital cable set-top built by General Instrument Corpor- |
| | ation of Horsham, Pennsylvania, USA (now the Broadband |
| | Communications Sector of Motorola, Inc.) that includes both |
| | cable and telephone modems. Newer models in this series in- |
| | clude the DCT2500 and DCT2600. The DCT2500 is a digital |
| | cable thin client set-top which offers all the features of the |
| | DCT2000, but adds processing power, scaled video, improved |
| | graphics and data extraction for text and other information |
| | services. (The term “Thin Client” refers to the concept of mini- |
| | mizing required storage, memory and computing horsepower at |
| | the user location by performing computing and storing informa- |
| | tion in a central location, with connections for user input and |
| | display over a medium-speed network.) The DCT2600 is a |
| | digital cable thin client set-top which offers all the features of |
| | the DCT2000, and adds processing power, scaled video, im- |
| | proved graphics, a hard disk for PVR use and data extraction |
| | for text and other information services. The DCT5000 is an ad- |
| | vanced digital cable thick client set-top that includes both cable |
| | and telephone modems. (The term “Thick Client” refers to the |
| | concept of robust computer processing power, storage, and |
| | memory within the end user's set top box or PC client. Soft- |
| | ware application(s) can and usually do reside at the user's |
| | location. Also known as “Heavy” Client.) |
| DVR | Digital Video Recorder. A high capacity hard drive that is |
| | embedded in a set-top box (STB), which records video pro- |
| | gramming from a television set. DVRs are operated by personal |
| | video recording (PVR) software, which enables the viewer to |
| | pause, fast forward, and manage various other functions and |
| | special applications. |
| EPG | Electronic Programming Guide. A channel selection (naviga- |
| | tional) device for digital TV which allows the user to search for |
| | a particular program by theme or other category, and order it to |
| | be displayed on demand. |
| HTTP | HyperText Transfer Protocol. The protocol for moving hypertext |
| | files across the Internet. Requires an HTTP client program on |
| | one end, and an HTTP server program on the other end. HTTP is |
| | the most common protocol currently being used in the World |
| | Wide Web (WWW). |
| Internet | The Internet (upper case “I”) is the vast collection of inter- |
| | connected networks that all use the TCP/IP protocols. The |
| | Internet now connects many independent networks into a vast |
| | global internet. Any time two or more networks are connected |
| | together, this results in an internet (lower case “i”; as in inter- |
| | national or inter-state). |
| IPG | Interactive Program Guide. This term suggests an EPG with |
| | more advanced features such as program searching by genre or |
| | title and one click VCR recording. |
| PVR | Personal Video Recorder. Software and data services combina- |
| | tion that allows viewers to interactively select programming |
| | choices they want to watch or record on their digital video |
| | recorder from an electronic programming guide (EPG). Data |
| | services are provided on a daily (e.g.) basis from the PVR |
| | provider. |
| Server | A computer, or a software package, that provides a specific kind |
| | of service to client software running on other computers. The |
| | term can refer to a particular piece of software, such as a WWW |
| | server, or to the machine on which the software is running. A |
| | single server machine could have several different server soft- |
| | ware packages running on it, thus providing many different |
| | servers to clients on the network. |
| Set-Top | Set Top, or “set-top box” (STB). An electronic device that al- |
| | lows a television (TV) set to connect to the Internet, game sys- |
| | tems or subscription television systems (e.g., cable or satellite). |
| TCP/IP | Transmission Control Protocol/Internet Protocol. This is the |
| | suite of protocols that defines the Internet. Originally designed |
| | for the UNIX operating system, TCP/IP software is now avail- |
| | able for every major kind of computer operating system. To be |
| | truly on the Internet, a computer must have TCP/IP software. |
| VOD | Video-On-Demand. The service of providing content through |
| | subscriber selection off a large menu of options, available to a |
| | viewer at any time. |
| WWW | World Wide Web. Frequently used when referring to the |
| | Internet, WWW has two major meanings. First, the whole |
| | constellation of resources that can be accessed using Gopher, |
| | FTP, HTTP, telnet, USENET, WAIS and other tools. Second, |
| | the universe of hypertext servers (HTTP servers) which are the |
| | servers that allow text, graphics, sound files, etc. to be mixed |
| | together. |

### SUMMARY OF THE INVENTION

According to the invention, generally, server software is utilized as a fundamental building block for the software architecture of digital television terminals (DCTs) and related devices (remote clients).

Methods and apparatus are disclosed for allowing an application running on at least one remote client device (such as a web pad, PC, laptop computer, PDA, dedicated remote control device, stereo system, digital terminal, television, etc.) to access or control content, services, and data available on a digital device/terminal (such as digital set-top terminal, television, stereo/audio device, PC, VCR, DVD player, PVR/DVR, gateway device, or the like). Such methods and apparatus comprise software (functions) such as application software (e.g., a web browser), server software (e.g., web server software), interface software (e.g., CGI Scripts/Servlets), network software (e.g., TCP/IP), and television/terminal control software running on the digital terminal. The methods and apparatus of the invention further comprise network software (such as TCP/IP), and application software (such as a web browser) running on the remote client device.

A communications link, which may be wired or wireless (e.g., radio frequency (RF) or infrared (IR)) is provided between the remote client device and the digital device/terminal.

According to a feature of the invention, the application software on the digital device/terminal may be a web browser, an EPG application, an IPG application, an e-commerce (electronic commerce) application, or a t-commerce (television commerce) application.

According to another feature of the invention, the application software on the client device may be a web browser, EPG application, IPG application, e-commerce application, and/or t-commerce application.

According to a further feature of the invention, the network software on the digital terminal can use TCP/IP protocols, and the network software on the client device can use TCP/IP protocols.

Network software on the digital terminal and the network software on the client device can comprise any suitable network software that supports open standard or proprietary networks.

The interface software can comprise an interface layer of software implemented in any programming language or scripting language that provides access to the terminal control software. The terminal control software can provide an interface to television functionality available in the digital terminal. For example, the terminal control software can include an application programming interface (API) providing at least one of the following functions or capabilities: tuning, purchasing, acquiring or selecting services; control of audio, video, on-screen display (OSD), password control, VOD, VCR, DVR/PVR, IR blaster, personal text messaging, IRR and front panel simulators; access to data or databases resident in the terminal; terminal configuration and status; unsolicited messages; configuration of RF output channels, AC Relay, RF Bypass, and AB output; and language configuration.

According to another aspect of the invention, a web page is stored on the digital terminal, and a user of the client device accesses the web page stored on the digital terminal to request specific actions to be performed or to request information. This is accomplished by the user requesting, via the client device, a specific web page. Thereafter, the client device communicates the request to the digital terminal, and the requested web page is retrieved by the server software and transmitted to and displayed on the client device by application software. The application software comprises, e.g., web browser software running on the client device. The user may subsequently make a selection and send a subsequent request back to the digital terminal. For example, the user may request that an associated television set be tuned to a specific television channel, in response to which the server software requests the terminal control software to tune the television to the specified channel. A new web page is then returned to the client device indicating that the channel was successfully tuned.

The present invention provides a common software architecture for television terminal resident applications and remote television client applications. This can reduce product development costs. The concepts described herein are also intended to provide an open and generic mechanism allowing for a simpler and more flexible application development environment for digital terminals (DCTs) than is currently available.

Based on the descriptions set forth herein, existing hardware and software (such as that provided by the Broadband Communications Sector of Motorola, Inc.) can readily be used and extended to implement the baseline architecture. Moreover, existing web server software (e.g.—HTTP, Apache, etc.) can compiled and configured for use on the DCT. The web server software can be downloaded to the DCT using broadcast channels (e.g., via an out-of-band data stream). Web pages can be hosted on the DCT and served to remote web client software, for example on a wireless web pad. In addition, a resident web browser on a DCT can access the web content without the need for a network connection.

The mechanism provided by the current invention can be utilized by any wired or wireless device to interface with a digital terminal. For example, web pads, DCPs, stereo equipment, PCs, other set-tops, hand held PDAs, cell phones, remote control devices, DVD players, VCRs, PVRs, and televisions may all connect to a digital terminal (DCT) to acquire information, or to control the terminal. In addition, the described mechanism can be utilized to provide head-end/system (i.e., “central system”) monitoring capabilities of a digital terminal. For example, a network operator could, using a web browser, login via a digital (e.g., broadband) network to a digital terminal and collect the status or diagnostics via a web page served by the targeted terminal. Other alternative and practical uses include 1) an efficient and scaleable framework for developing test applications for digital terminals and 2) a simplified development environment for third party application/content developers.

An example of a remote client device is the Motorola EVr-8401, which is a touch-screen, hand-held device that offers interactive television viewers a second screen for accessing Internet content relating to the TV programming they are watching. The EVr-8401 wirelessly connects to either a Motorola DCT5000 family advanced interactive digital set-top terminal's cable modem or a stand-alone cable modem for a portable “always-on,” high-speed broadband connection. Users are able to casually view Internet content on the EVr-8401 while they and those also in the room continue watching TV programming—uninterrupted and in full-screen video. Macromedia Flash Player is a standard multimedia player for delivering effective Web interfaces and engaging, branded experiences online. With such player support on the Motorola EVr-8401, the community of multimedia player developers can rapidly deliver compelling content and rich applications that can also be accessed by consumer users. This will provide users with truly unique, interactive television experiences, and will enable broadcasters and operators to deliver powerful and engaging applications. Multiple users can share information and move from room-to-room and television-to-television without disrupted service. With such a multimedia player, consumers can surf the Internet, e-mail, and chat with others, all using a familiar and intuitive user interface to maximize their viewing experience.

Other examples of remote clients that can be used in connection with the invention include personal computers (PC), wireless handheld devices (e.g., Palm Pilots), wireless phones, additional televisions or set tops in the home, PVRs, advanced stereo systems, internet telephones (IP phones), residential gateway devices, and the like.

### BRIEF DESCRIPTION OF THE DRAWINGS

FIG. 1 is a diagram showing a simple prior art client/server system;

FIG. 2 is a diagram of another typical prior art client/server system;

FIG. 3 is a diagram showing a framework for allowing remote client devices, and applications that run on them, to access or control content, services, and data available on a digital terminal, according to the invention; and

FIG. 4 is a diagram showing an example of how the framework described in FIG. 3 can be utilized, according to the invention.

### DETAILED DESCRIPTION OF THE INVENTION

The present invention relates to interactive digital television terminals, and more particularly to software architecture for digital set-top boxes (also known as digital consumer terminals or DCTs). The invention provides a client/server software architecture whereby one or more remote clients (e.g., browser) and/or local clients (e.g., local client browser in the set-top box) can communicate with server software running on the set-top box to permit interactive access to program selection, control, and data features within the set-top box. This permits remote devices to access and control “standard” television functions (e.g., EPG), enhanced television applications (e.g., PVR), and application interfaces between digital set-top boxes and in-home products (e.g., PDA's, Web Pad).

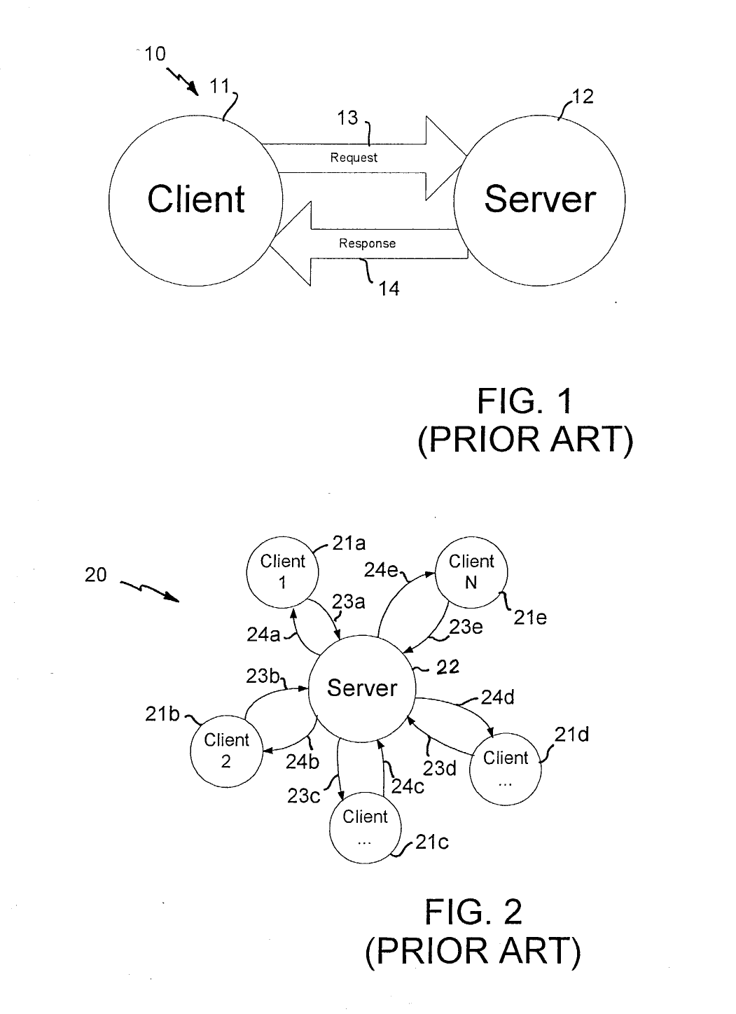

Client/Server software typically involves a process in which one or more software agents (clients) communicate with server agents (servers). FIG. 1 is a block diagram of a communication system 10 illustrating a simple client/server model wherein one client 11 communicates with one server 12. The client 11 establishes a connection with the server 12 and issues requests 13 to the server. The server 12 in turn responds to the requests 13 and takes action appropriate thereto on behalf of the client 11 and formulates responses 14 to be issued back to the client 11.

FIG. 2 is a block diagram of a more complicated communication system 20, illustrating a more complex client/server model wherein multiple clients 21a, 21b, 21c, 21d, 21e, etc. communicate with a single server 22. Each client 21‘x’ individually establishes a connection with the server 22 and issues requests 23a, 23b, 23c, 23d, 23e, etc. The server 22 responds separately to each request 23‘x’ and formulates corresponding responses 24a, 24b, 24c, 24d, 24e, etc. to be issued back to the associated client 21‘x’. A variety of different techniques, well known to those of ordinary skill in the art, can be employed by the server 22 to determine an order in which requests 23‘x’ are processed based on scalability and performance needs of the system 20.

FIG. 2 is a very general model of multiple-client/single-server communications. For example, this model is representative of world-wide-web browsers (clients, e.g., 21‘x’) and web servers (e.g., 22) where many browsers can simultaneously (contemporaneously) communicate with a web server. Client browsers establish communication with the web server by first resolving a domain name (e.g. www.mot.com) into an IP address (e.g. 129.188.137.156) of the web server. Then a “socket” connection is established with the server on port 80 (this is the pre-defined port for the HTTP protocol used by web pages). Once communication has been established between the client machine and the server machine, the client can issue an HTTP request. The server receives, parses, acts upon the request and responds to the client appropriately.

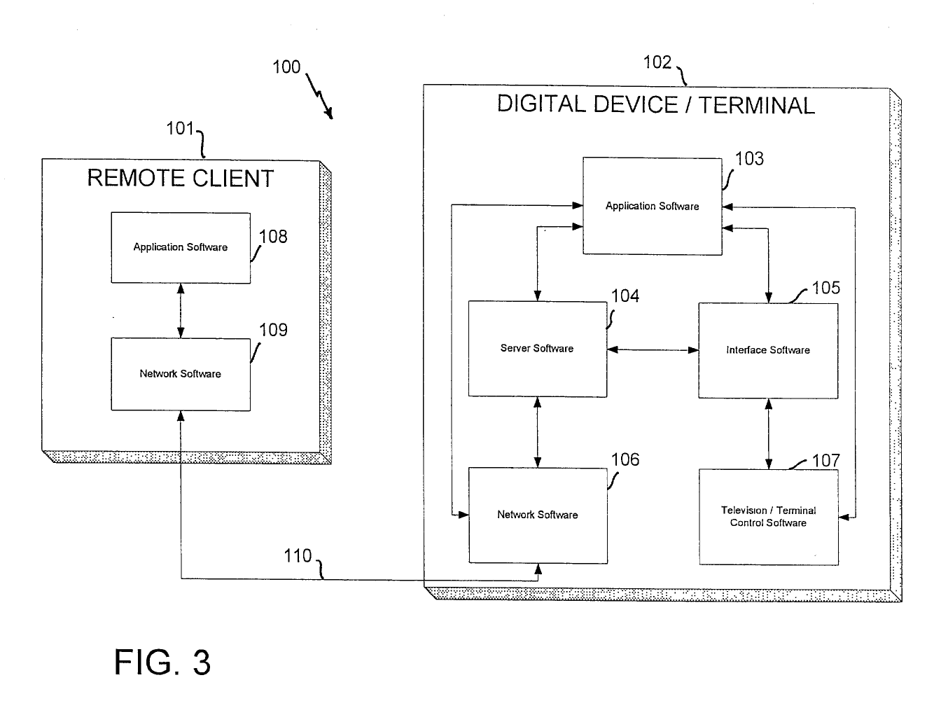

FIG. 3 is a diagram illustrating a software architecture 100 for allowing one or more remote client devices 101, and applications that run on them, to access or control content, services, and data available on a digital terminal 102 (e.g., set-top box, DCT), according to the invention. Running on the digital terminal 102 is application software 103, server software 104, interface software 105, network software 106, and television/terminal control software 107. Running on the remote client 101 is network software 109 and application software 108. A generic wired or wireless (including RF, IR) communications link 110 is shown linking the remote client 101 and the digital terminal 102. The software 108 and 109 is stored in memory and executed by a processor in the remote client 101, and the software 103, 104, 105, 106 and 107 is stored in memory and executed by a processor in the digital terminal 102.

For the purposes of the software architecture 100 of FIG. 3, a remote client device 101 would be, for example, a Web Pad, a PC or laptop computer, a handheld PDA, a dedicated remote control device, a stereo system, another set-top terminal, a television, or the like. A typical digital terminal would be, e.g., a digital set-top terminal, a television, a stereo/audio device, a PC, a VCR, a DVD player, a PVR/DVR, or a gateway device. The application software 103 on the digital terminal 102 and the application software 108 on the remote client device 101 would typically be a web browser, EPG application, IPG application, e-commerce application, or t-commerce application. The network software 106 and 109 on the digital terminal 102 and remote client device 101, respectively, is preferably TCP/IP and any device drivers necessary to support it. Alternatively, the network software 106, 109 could be any suitable network software that supports open standard or proprietary networks. The interface software 105 is an interface layer of software implemented in any programming language or scripting language (e.g. C/C++, Peri, PHP, Java, etc.) that provides access to the television/terminal control software 107. The television/terminal control software 107 provides an interface to television functionality available in the terminal 102. For example television/terminal control software 107 may include an API (application programming interface) providing functions or capabilities such as: tuning, purchasing, acquiring or selecting services; control of audio, video and on-screen display (OSD); password control; VOD, VCR, DVR/PVR; IR blaster; personal text messaging; IRR and front panel simulators; access to data or databases resident in the terminal; terminal configuration and status; unsolicited messages; configuration of RF out channels; AC Relay, RF Bypass, and AB output; and language configuration.

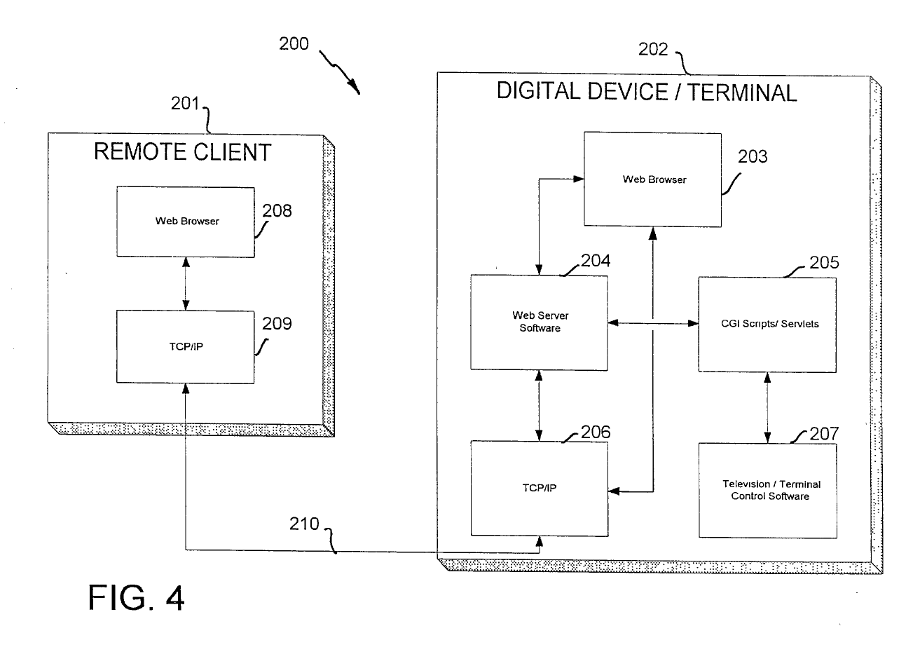

FIG. 4 is a diagram of a client/server system 200 exemplary of how the software architecture shown and described hereinabove with respect to FIG. 3 can be applied. The system 200 of FIG. 4 comprises a remote client device 201 (compare 101) and a digital device/terminal 202 (compare 102). Running on the digital device/terminal are a web browser application 203 (compare 103), web server software 204 (compare 104), CGI Scripts/Servlets 205 (compare 105), TCP/IP software 206 (compare 106), and television/terminal control software 207 (compare 107). Running on the remote client device 201 is TCP/IP software 209 (compare 109) and a web browser application 208 (compare 108). A generic wired or wireless communications link 210 (compare 110) is shown linking the remote client 201 and the digital terminal 202. The software 208 and 209 is stored in memory and executed by a processor in the remote client 201, and the software 203, 204, 205, 206 and 207 is stored in memory and executed by a processor in the digital terminal 202.

In this exemplary case, the digital device/terminal 202 is a set-top box such as a DCT5000 terminal manufactured by Motorola, Inc., running web server software 204 such as Apache Web Server and CGI scripts and servlets to allow the remote client 201 to connect to and control the television terminal control software 207 on the terminal 202. The remote client device can be, for example, a handheld wireless PDA, in which case the TCP/IP software 209 on the remote client (PDA) 201 communicates with the corresponding TCP/IP software 206 running on the digital terminal (DCT5000) 202 via a wireless medium (such as IEEE 802.11b or IrDA). The web browser 208 connects to the web server software 204 via the connection established between the TCP/IP software (206, 209) running on the remote client 201 and the digital terminal 202. By way of this mechanism, a user of the PDA can access web pages (e.g., stored in the form of CGI scripts/servlets 205) on the digital terminal 202 to request specific actions to be performed or to request information. For example, the remote client 201 might make a request via the server software 204 to display a specific web page. The requested web page would be retrieved by the server software 204 and transmitted to and displayed on the remote client 201 by means of the web browser software 208 running thereon. Assuming that the purpose of the web page is to make channel selections, the user of the remote client could then make a selection that would send a request back to the digital terminal 202 to tune the associated television set (not shown) to a specific television channel. The web server software 204 would then execute a corresponding CGI script 205 to request the television terminal/control software 207 to tune to the specified channel and to return a new web page to the remote client 201 indicating that the channel was successfully tuned.

Although the invention has been described in connection with various specific embodiments, those skilled in the art will appreciate that numerous adaptations and modifications may be made thereto without departing from the spirit and scope of the invention as set forth in the claims.

What is claimed is:

1. A method of allowing an application running on at least one client device to access or control content, services, and data available on a digital terminal, comprising:
providing the digital terminal with application software, server software, interface software, network software, and terminal control software;
providing the client device with network software and application software; and
providing a communications link between the client device and the digital terminal.

2. A method according to claim 1, wherein the digital terminal comprises at least one of a digital set-top terminal, television, stereo/audio device, PC, VCR, DVD player, PVR/DVR, or gateway device.

3. A method according to claim 1, wherein the client device comprises at least one of a web pad, DCP, stereo equipment, PC, laptop computer, other set-top, PDA, hand held PDA, cell phone, remote control device, DVD player, VCR, PVR, television, and another digital terminal.

4. A method according to claim 1, wherein the communications link is wired or wireless.

5. A method according to claim 1, wherein the application software on the digital terminal comprises at least one of a web browser, EPG application, IPG application, e-commerce application, or t-commerce application.

6. A method according to claim 1, wherein the application software on the client device comprises at least one of a web browser, EPG application, IPG application, e-commerce application, or t-commerce application.

7. A method according to claim 1, wherein the network software on the digital terminal uses TCP/IP protocols, and the network software on the client device uses TCP/IP protocols.

8. A method according to claim 1, wherein the network software on the digital terminal and the network software on the client device comprises any suitable network software that supports open standard or proprietary networks.

9. A method according to claim 1, wherein the interface software comprises an interface layer of software implemented in any programming language or scripting language that provides access to the terminal control software.

10. A method according to claim 1, wherein the terminal control software provides an interface to television functionality available in the digital terminal.

11. A method according to claim 1, wherein the terminal control software includes an application programming interface (API) providing at least one of the following functions or capabilities: tuning, purchasing, acquiring or selecting services, control of audio, video, on-screen display (OSD), LED display, password control, VOD, VCR, DVR/PVR, IR blaster, personal text messaging, IRR and front panel keypad simulators, access to data or databases resident in the terminal, terminal configuration and status, unsolicited messages, configuration of RF out channels, AC Relay, RF Bypass, and AB output, and language configuration.

12. A method according to claim 1, further comprising:
storing a web page on the digital terminal;
wherein specific actions to be performed or requests for information can be made by accessing said web page.

13. A method according to claim 12, wherein:
said web page is accessible via the client device.

14. A method according to claim 13, wherein:
a selection is made using said web page on the client device; and
the selection causes a request to be sent to the digital terminal to tune an associated television set to a specific television channel.

15. A method according to claim 14, wherein:
the server software comprises web server software, which requests the terminal control software to tune the television to the specified channel and returns a new web page to the client device indicating that the channel was successfully tuned.

16. A digital television terminal, comprising:
a web browser application;
web server software;
CGI Scripts/Servlets;
TCP/IP software; and
television/terminal control software;
the digital television terminal being linked via a communications link to a remote client device comprising:
TCP/IP software; and
a web browser application.

17. A digital television terminal according to claim 16, wherein:
the communications link is wired or wireless.

18. A digital television terminal according to claim 16, comprising at least one of a digital set-top terminal, television, stereo/audio device, PC, VCR, DVD player, PVR/DVR, or gateway device.

19. A digital television terminal according to claim 18, wherein the client device comprises at least one of a web pad, PC, laptop computer, PDA, dedicated remote control device, stereo system, another digital terminal, or television.

20. A digital television terminal according to claim 16, wherein the client device comprises at least one of a web pad, PC, laptop computer, PDA, dedicated remote control device, stereo system, another digital terminal, or television.

21. A digital television terminal comprising:
memory for storing server software; and
a processor for executing said server software;
wherein:
said server software is adapted to serve a client device with pages viewable on a browser; and
said terminal is adapted to receive commands from said client device, said commands being entered by a user via said pages.

22. A method of providing a network operator with central system monitoring of a remote digital terminal comprising:
providing the digital terminal with interface software accessible to the central system; and
allowing the network operator to access the digital terminal from the central system via a digital network, using a web browser to collect status or diagnostic information via a web page served by the terminal.

23. A method according to claim 22, wherein the digital terminal comprises at least one of a digital set-top terminal, television, stereo/audio device, PC, VCR, DVD player, PVR/DVR, or gateway device.

24. A method according to claim 22, comprising:
providing the digital terminal with application software, server software, network software, and terminal control software in addition to said interface software.

25. A method according to claim 24, wherein the application software comprises at least one of a web browser, EPG application, IPG application, e-commerce application, or t-commerce application.

26. A method according to claim 24, wherein the network software uses TCP/IP protocols.

27. A method according to claim 24, wherein the terminal control software includes an application programming interface (API) providing at least one of the following functions or capabilities: tuning, purchasing, acquiring or selecting services, control of audio, video, on-screen display (OSD), LED display, password control, VOD, VCR, DVR/PVR, IR blaster, personal text messaging, IRR simulation, front panel keypad simulation, access to data or databases resident in the terminal, terminal configuration and status, unsolicited messages, configuration of RF out channels, AC Relay, RF Bypass, AB output, and language configuration.
